(19) United States
(12) Patent Application Publication
(10) Pub. No.: US 2013/0126647 A1
(43) Pub. Date: May 23, 2013

(54) Comminution Reactor

(71) Applicants: Charles Allen Arnold, Lakewood, CO (US); Eric Lundgren, Littleton, CO (US)

(72) Inventors: Charles Allen Arnold, Lakewood, CO (US); Eric Lundgren, Littleton, CO (US)

(21) Appl. No.: 13/698,140

(22) PCT Filed: May 20, 2011
(86) PCT No.: PCT/US2011/037451

§ 371 Date: Jan. 7, 2013

Related U.S. Application Data
(60) Provisional application No. 61/344,092, filed on May 21, 2010.

(51) Int. Cl. B02C 13/26; B02C 13/288

(52) U.S. Cl. CPC B02C 13/26; B02C 13/288
USPC 241/18; 241/188.1; 241/38; 241/25

(57) ABSTRACT

A comminution reactor includes an inlet chamber, one or more processing chambers, and a discharge chamber. Each chamber includes a rotor, and the chambers are separated by split divider plates. The reactor is designed with assemblies comprising portions of the reactor walls and divider plates which rotate open to allow access to the inside of the reactor, including the shaft and attached rotors. The design of the rotors and vortex generators on the reactor walls direct the flow, optimize comminution, and minimize wear on the apparatus.

### BACKGROUND OF THE INVENTION

1. Technical Field

The present invention relates to apparatus and methods for comminuting materials.

2. Background Art

Known milling techniques and apparatus, such as roller and ball mills, are generally based on either impact or compression forces or a combination thereof. These forces mimic what nature has done for millions of years. A typical example is a river gradually breaking down riverbed rocks. Nature, as well as traditional milling techniques, tend to create variably sized round particles with passive surfaces. Any impurities in the original material, if soft compared to the other components, are smeared and furthermore small fissures in the original source are closed. These issues are specifically troublesome within the mining industry. Gone are the days of large concentrations of minerals. Today the industry is overwhelmingly faced with the challenge of liberating and separating micro-sized valuables in large volume source material. Ore must be crushed into small enough particles that chemical agents can leach the desired metal from the ore.

Typical devices for comminuting (or pulverizing) materials include a rotatable shaft within a housing, with rotor plates attached to the shaft and separated by baffles attached to the housing for directing flow. Material is introduced into one end of the housing, the rotor plates sequentially spin and agitate the material, and the pulverized material is removed from the other end of the housing. Comminuting devices of this sort quickly break down materials into small, uniform particles. U.S. Pat. No. 4,886,216 to Goble as well as two patents issued to one of the present inventors, U.S. Pat. Nos. 6,135,370 and 6,227,473 teach this sort of device.

These sorts of comminution devices are an improvement over traditional milling devices, but they have disadvantages related to extensive wear on the equipment in combination with limited to no access to the interior for maintenance and cleaning.

A need remains in the art for comminuting methods and apparatus which improve equipment life and allow for access to the interior of the apparatus.

### SUMMARY OF THE INVENTION

It is an object of the present invention to provide apparatus and methods which improve equipment life and allow for access to the interior of the apparatus. A comminuting reactor according to the present invention includes inlet, process and discharge chambers. The chambers are constrained by retainer plates lined with floating wear plates and are separated by segmented split divider plates. A rotating shaft extends through the device.

In one embodiment, the inlet chamber is located at the bottom of the reactor, and has inlet ports through which material and fluids are drawn by suction. The inlet chamber may also be at the top of the reactor and the material and fluid may be gravity fed. Note that the terms “top” and “bottom” are used for convenience in describing the figures, but are not intended to limit the orientation of the reactor.

The inlet ports may be oval to minimize bridging issues. The inlet chamber may form a dome shape to provide a volume for materials and fluids to impact each other and the dome to blend in a chaotic manner. The mixture then is organized into a fluid stream before transitioning into an adjacent processing chamber. In a preferred embodiment, an inlet rotor attached to the shaft has straight vanes leading from the shaft to the circumference. The vanes have bull-nose top edges. The inlet rotor causes low pressure and sucks the mixture into the inlet chamber.

Vortex generators are formed on the floating wear plates of the inlet chamber. A secondary set of vortex generators are located in each apex of the polygon shaped chamber. The inlet rotor forces the fluid and the material outwards and form it into a stream. When this stream interacts with the vortex generators, each vortex generator sets up two counter-rotating, to the main stream, vortexes. One or several processing chambers may be used depending on the materials and desired level of comminution. Each processing chamber includes a processing rotor plate and vortex generators on its floating wear plates to control the flow and optimize comminution and equipment life. In each processing chamber, the mixture stream enters near the center of the chamber as guided by the segmented split divider plates forming its entry. The rotor plate forces the stream outward toward the chamber's floating wear plates. One set of vortex generators are located on the floating wear plates, and another set of vortex generators are individually located in the apexes of the chamber. The mixture flow is forced outward by the rotor and encounters these vortex generators, which, due to their shape and location, cause material particles to swirl back against the main flow and collide in the fluid. The collisions cause the particles to break along natural boundaries. In this sort of random, high frequency collision environment, one side of a colliding particle tends to contract while the other opposite side tends to stretch. If repeated numerous times the end result is comminution with jagged edges and unique aspect ratios. In a preferred embodiment, compared with prior art, each processing chamber rotor has a scalloped circumference with vanes that originate from the central hub and radiate in a curved shape to the circumference. The scallops are offset towards the convex side of each vane. The fluid/material mixture is centrifugally forced to the wear plates where the mixture encounters the vortex generators.

A discharge chamber follows the segmented divider plate of the last processing chamber. The discharge rotor is round and has straight vanes that originate at its central hub and terminate at its circumference. The vane height is greater than that of the processing rotor vanes. The material is discharged laterally through single or multiple discharge ports or volutes.

In a preferred embodiment, the reactor has individual floating wear plates that form a regular polygon. The vortex generators within each chamber are located in each apex of the polygon and on each of the individual floating wear plates. These vortex generators have multiple purposes such as increasing material resident time, reducing wear of the comminution reactor floating wear plates and optimizing the impact and shearing forces.

In a preferred embodiment, the horizontal chamber, comprising retainer plates restrained by the segmented split divider plates, positions the floating wear plates to form a polygon shaped chamber. This design allows open access to the interior of the reactor. The segmented split divider plates are hinged on rods that allow a segment to open and move away from the shaft and rotor plates. Exterior recessed mounted bearing housings are located outside either end of the reactor. A balancing ring is mounted on the shaft of the comminution reactor just beyond the bearing housings. The comminution reactor mounting is designed to allow for the inversion of the entire comminution reactor.

### BRIEF DESCRIPTION OF THE DRAWINGS

FIG. 1 is a schematic side view of a comminution reactor according to the present invention attached to an electric motor on a common stand with an air separator and a feed container attached.

FIG. 2 is a vertical cross-sectional view of the comminution reactor in accordance with several embodiments of the present invention.

FIG. 3 is a plan view of the inlet rotor of the reactor of FIG. 2. FIG. 3A is a cross-section view of an inlet rotor vane showing the bull-nose vane design.

FIG. 4 is a plan view of a processing rotor of the reactor of FIG. 2. FIG. 4A is a side cross-section view of the processing rotor.

FIG. 5A is a cutaway plan view of a processing chamber of the reactor of FIG. 2.

FIG. 5B is a cutaway plan view of a processing chamber with opened segmented divider plates also showing one machine plate.

FIG. 6 is a detailed cutaway plan view of a portion of a processing chamber showing vortex generators formed at the apexes of two floating wear plates and vortex generators formed on floating wear plates as well as a probe inserted into a fluid injection port in a segmented divider plate.

FIG. 7 is a front view of a floating wear plate. FIG. 7A is a cross-section view of the floating wear plate.

FIG. 8A is a cutaway plan view of a single dual discharge volute. FIG. 8B is a cutaway plan view of a dual discharge volute.

FIG. 9 is a plan view of a discharge rotor. FIG. 10A is cross-section view of the discharge rotor.

FIG. 10 is a schematic side cutaway view of the reactor assembly showing material and fluid flow through the inlet chamber, one processing chamber, and the discharge chamber.

FIG. 11. Is a schematic plan cutaway view showing the material and fluid flow inside a processing chamber.

### DETAILED DESCRIPTION OF THE INVENTION

The following reference numbers are used in the figures:

| | |
|---|---|
| 1 | Inlet Chamber |
| 2 | Bearing and seals housing |
| 3 | Shaft |
| 4 | Balancing ring |
| 5 | Power driving coupling |
| 6 | Inlet ports |
| 7 | Extra inlet port valve |
| 8 | Small inlet port valve |
| 9 | Small inlet ports |
| 10 | Rod Machine Plate |
| 11 | Hub/shaft keys |
| 12 | Processing rotor vanes |
| 13 | Processing rotor scallops |
| 14 | Shaft protection sleeve |
| 15 | Floating Wear Plates |
| 16 | Vortex generator on floating wear plate |
| 17 | Vortex generator at apexes |
| 18 | Segmented split divider plate |
| 19 | Probe holes segmented divider plate |
| 20 | Retainer plates |
| 21 | Processing chamber |
| 22 | Processing rotor |
| 23, 23A, | Material Flow |
| 23B | |
| 24 | Inlet end rotor |
| 25 | Inlet rotor vanes - bull nose shaped |
| 26 | Inlet rotor scallops |
| 27 | Inlet Dome |
| 28 | Machine plate |
| 29 | Retainer Rod |
| 30 | Discharge rotor vanes |
| 31 | Discharge chamber |
| 32 | Discharge rotor |
| 33 | Shaft/hub keys |
| 34 | Retainer Rod opening in Retainer Plate |
| 35 | Single Dual volute discharge |
| 36 | Dual Volute discharge |
| 37 | O-ring |
| 38 | Discharge stage shaft opening |
| 39 | Inscribed circle vortex generator apex |
| 40 | Inscribed circle vortex generator center |
| 42 | Outside shaft protector |
| 43 | Balancing ring keys |

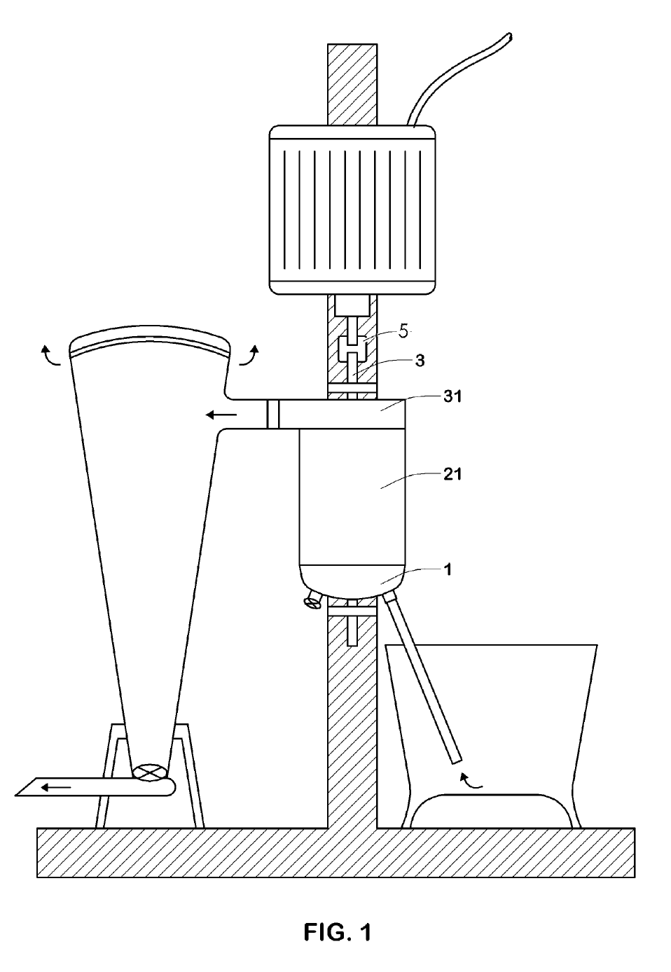

FIG. 1 is a schematic side view of a comminuting reactor assembly according to the present invention, including a comminuting reactor attached to an electric motor via a power coupling 5, on a common stand with an air separator and a feed container attached. The comminuting reactor inverts such that inlet end may be at the top or the bottom. If inlet end is located at the bottom of reactor (as shown in FIG. 1), material 23 and fluids are drawn by suction. The inlet end may also be at the top of the reactor and the material and fluid may be suction/gravity fed.

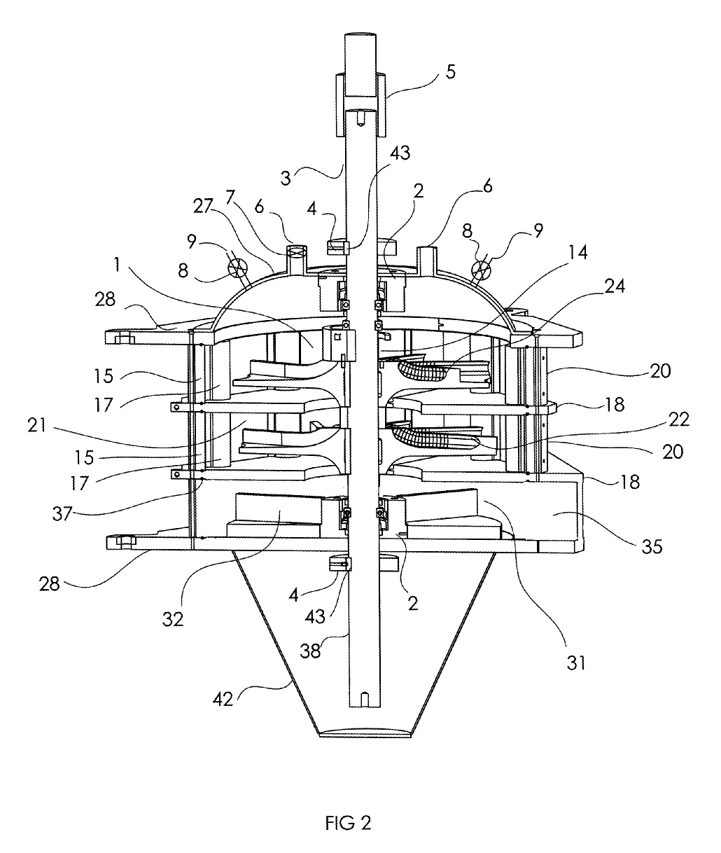

FIG. 2 is a vertical cross-sectional view of an embodiment of the comminution reactor assembly, with reactor inlet end toward the top of the figure. The reactor assembly has at its inlet end a bearing and seals housing 2 recessed into inlet end dome 27.

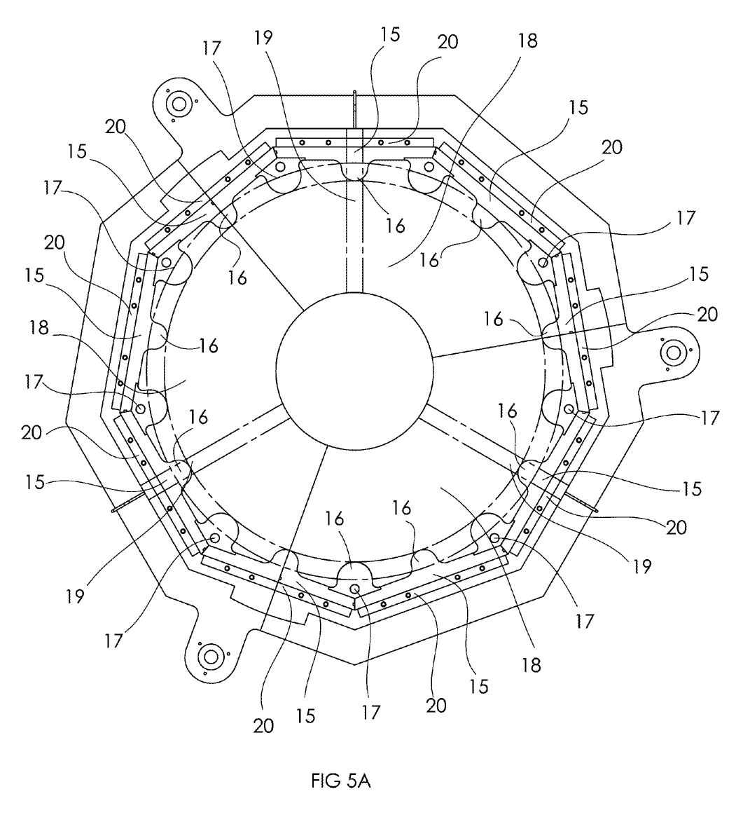

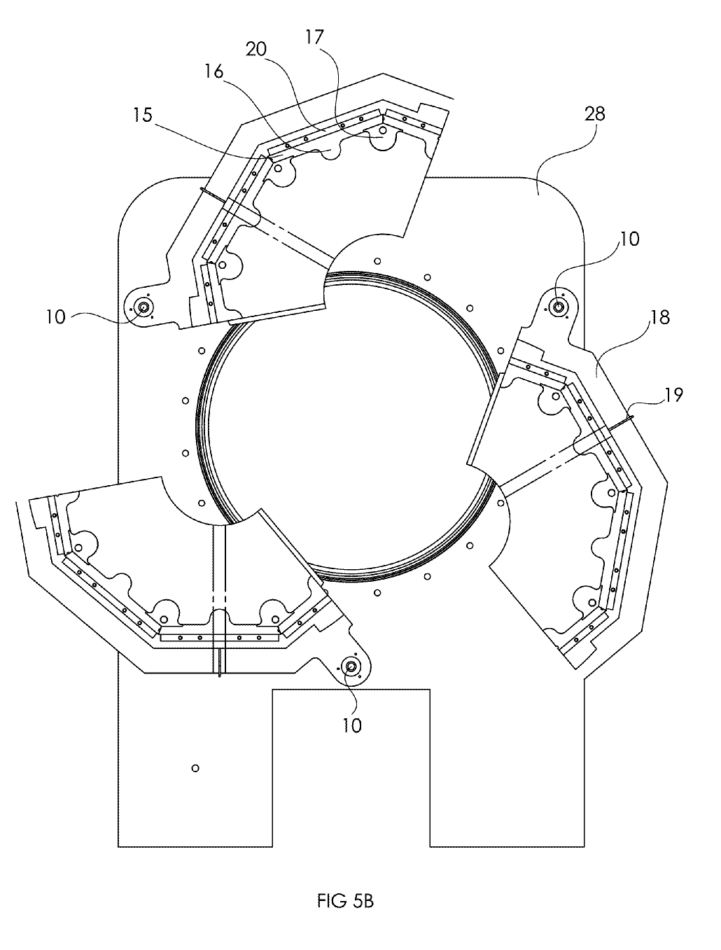

Dimensions and materials are given for an example embodiment below. Those skilled in the art of milling and pulverizing apparatus will appreciate that many variations on the example herein are within the spirit of the present invention. The cast material of the dome in one embodiment would be 17-4 ph stainless steel and in general is process dependent. The dimensions in one embodiment is about 3 inches high and 28½ inches in diameter according the polygon shaped inlet chamber (see discussion relating to FIG. 5A). Inlet processing chamber 1 extends to the segmented split divider, and provides a space for the initial movement and mixing of material 23 to be comminuted. Shaft 3 in one embodiment would be 4043 steel and 66½ inches long and 2⅜ inches in diameter. It extends externally beyond the reactor inlet end 1 and has a balancing ring 4 keyed with two 90-degree off-set keys 43 that mounts outside seal and bearing housing 2. Shaft material is process dependent, and dimensions are according to the process chamber size and numbers. Beyond balancing ring 4 is power driving coupling 5. The inlet dome 1 has oval shaped material inlet ports 6, in one application 5 inches by 6 inches with valve(s) 7 and small inlet ports 9, for example ½ inch diameter with valves 8, for additional fluids.

Discharge end 31 has an opening 38 in the center for shaft 3 to penetrate. Discharge end 31 houses discharge end bearings and seals housing 2. Shaft 3 extends beyond discharge end 31 and has a discharge end balancing ring 4 keyed with two 90-degree off-set keys 43 to shaft 3 within outside safety protector 42. Shaft 3 extends beyond balancing ring 4 to a drive coupling (not shown) should the reactor be driven from this end. This feature permits the reactor to be driven from either end.

The reactor comminutes materials of all types and descriptions in all types of fluid medias. The reactor includes several improvements over known devices for comminuting material. For example, the reactor is designed to allow access to the interior of the reactor, for maintenance, cleaning and the like. The reactor includes segmented assemblies which pivot away from shaft 3 and rotor plates 22, 24, 32 (see FIG. 5B). Reactor chambers comprise retainer plates 20 restrained by segmented divider plates, for example by using set screws to hold the wear plates in position. The retainer plates 20 position the floating wear plates 15 which form a polygon (see FIG. 5A). Rotor plates 22, 24, 32, along with vortex generators 16, 17 and floating wear plates assist in flow control and comminution (See FIGS. 5A, 10 and 11). The required characteristics of materials in these components are dependent upon the comminuted material.

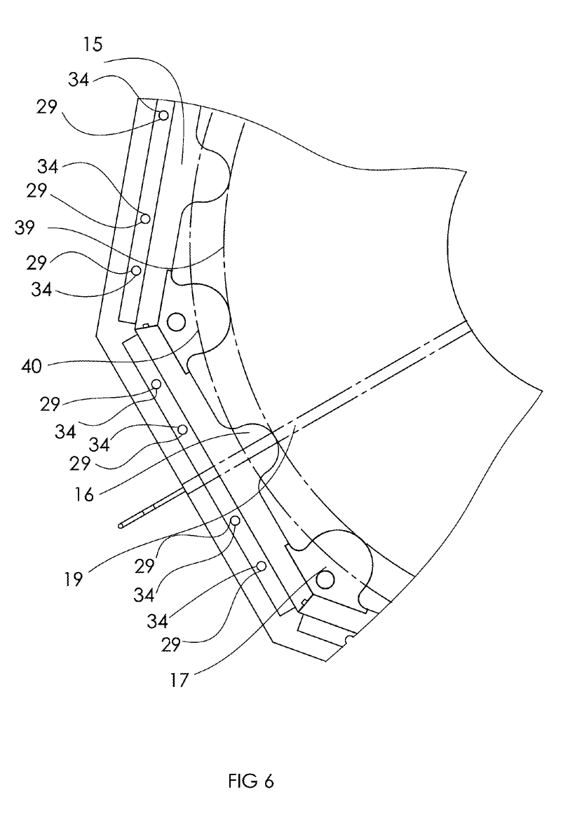

The comminuting reactor of the present invention is composed of an inlet chamber 1, processing chamber(s) 21 and a discharge chamber 31. Each chamber is individually constrained by floating wear plates 15 positioned by retainer plates 20. In one application the wear plates have the dimensions of 4½ inches high and 9 inches long and are made of hardened 17-4 ph stainless steel and the retainer plates have the dimension of 4¼ inch high and 8¾ inch long and are made of 304 stainless steel. Retainer plates 20 are restrained by retainer rods passing through retainer rod openings in retainer plates 20 and the segmented divider plates 18 (see FIG. 6). The floating wear plates 15 have wear plate vortex generators 16 running down the centers of the wear plates and they form a polygon. Located at each apex of the polygon within inlet chamber 1 and the processing chamber(s) 21 is an apex vortex generator 17 (see FIG. 6). Each apex vortex generator 17 is attached to a segmented divider plate 18.

A series of rotor plates including an inlet rotor 24, processing rotors 22, and discharge rotor 32 are attached to shaft 3. In one embodiment the rotors have a diameter of 21 inches and are made of cast hardened 17-4 ph stainless steel. Shaft 3 extends through and beyond comminution reactor. The reactor has inlet end 1 having at least one feed port 6 for the material 23 to be comminuted, and at least one injection port 9 for additional fluids. Discharge end 31 discharges fluids laterally through a single or double volute 35 or 36. The reactor comminutes materials 23 with both impact and shear forces. The reactor has a variable number of processing rotors 22 that corresponds with the number of processing chambers 21. The actual number of processing chambers 21 is dependent on the materials or products. The direction of rotation of the rotor assembly is material dependent and the reactor is designed to rotate in either a CW-CCW direction and to be operational in the inverted position. The shaft and rotors rotate on the order of 5,000 rpm. Particles within the reactor travel at speeds exceeding sound. Material passes trough the entire reactor in about one thousandth of a second.

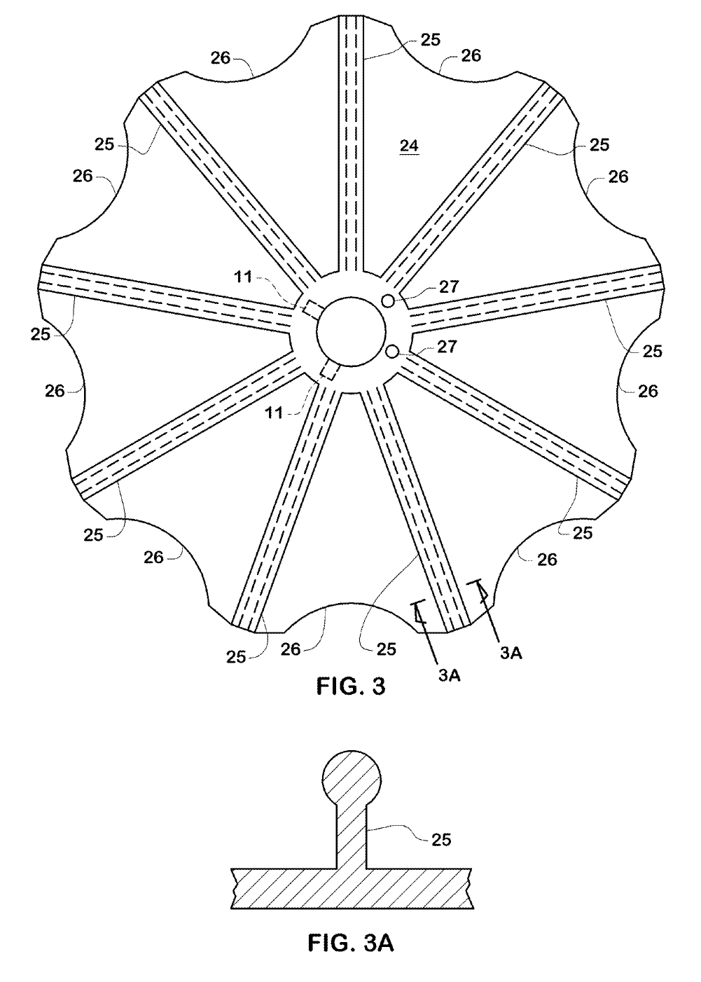

FIG. 3 is a plan view of one embodiment of inlet rotor 24. FIG. 3A is a cross-section view of a vane 25 showing its bull-nose vane design. Inlet rotor 24 has vanes 25 that originate at the central hub and radiate in a straight line to the circumference of rotor 24. The shape of vanes 25 is vertical with a bull nose shape at the top. The circumference of inlet rotor 24 is scalloped and the scallops 26 are spaced equidistant between each vane 25. Shaft 3 (see FIG. 2) penetrates the central hub of inlet rotor 24. Inlet rotor 24 is attached to shaft 3 with two keys 11 spaced 90° apart.

There exists a shaft protection sleeve 14 (see FIG. 2) between the inside of the inlet dome and the central hub of inlet rotor 24. Protection sleeve 14 is pinned by two pins spaced 90° apart (not shown) and opposite keys 11 of inlet rotor 24. Similar sleeves may be used between rotors as spacers. This design enables inlet rotor 24 to operate in an efficient manner without regard to the direction of rotation or orientation. Materials 23 impacts with bull nose shaped vanes 25 and are ejected toward floating wear plates 15. The vertical sections of vanes 25 guide material 23 toward floating wear plates 15 and vortex generators 16, 17.

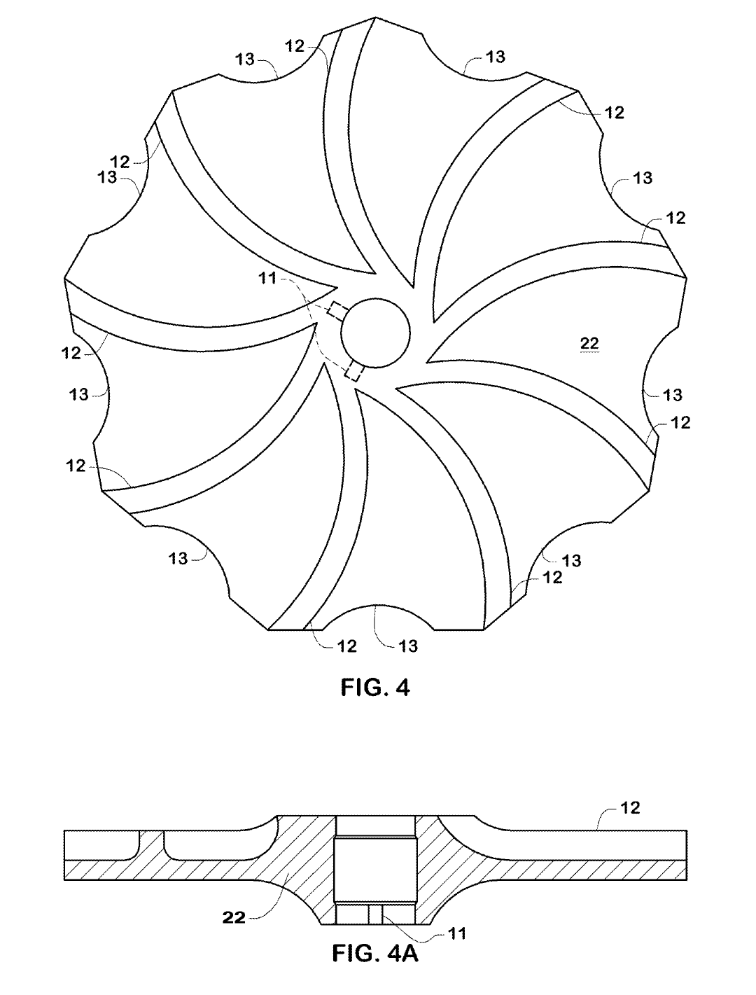

FIG. 4 is a plan view of a processing rotor 22. FIG. 4A is a side cross-section view of processing rotor 22. Processing rotor 22 has a scalloped circumference with the scallops 13 located between each rotor vane 12. The scallops are offset to the convex side of vanes 12. Processing rotor vanes 12 originate at the central hub and radiate in a curved path that terminates in a straight section of the circumference. Vanes 12 form a curved cup on the concave side of the vane and the other side of the vane forms a perpendicular face. With vanes 12 configured to eliminate the straight section of the vane and have the curve continue to the circumference in front of the leading scallop in a clockwise direction higher temperatures are created which increases drying.

The central hub has an opening for shaft 3 to penetrate and is keyed to shaft 3 with two keys 11, spaced 90° apart. Keys 11 can be used to clock processor rotors, to minimize the potential for resonance and standing waves in the reactor.

Compared to prior art the clocking of the individual rotors are done by the clocking key ways in the shaft. Hereby all rotors are identical and assembly can only be accomplished one way. Manufacturing cost are kept to a minimum and assembly mistakes are eliminated.

One configuration that works well is a pair of parallel keys that are indexed from the next pair of parallel keys by the following formula:

360°/Sₜ*Vₜ=degree of index
Sₜ=Total number of sides in one stage
Vₜ=Total number of vanes as counted on all rotors

FIG. 5A is a cutaway plan view of a processing chamber 21. Discharge end machine plate extends out past segmented split divider plates 18, retainer plates 20, and floating wear plates 15. Floating wear plate vortex generators 16 extend inward from floating wear plates 15. Apex vortex generators are located at the apexes of the polygon formed by the floating wear plates 15. Retainer plates 20 are restrained by the segmented split divider plates 18 by retainer rods 29 through openings 34 Probes not limited to measuring temperatures and pressures can be inserted into the processing chamber 21 via probe holes 19. The same probe holes can be used for injection of any needed fluids.

Note the imaginary outer inscribed circle 40 and inner inscribed circle 39 shown in FIG. 6. Outer inscribed circle 40 passes through the axis of the inward facing curve of each apex vortex generator 17 as well as following the inscribed circle formed by the polygon shaped floating wear plates 15. Inner inscribed circle 39 indicates the inner edge of the floating wear plate vortex generators 15 and all secondary vortex generators located in each apex of the polygon. As the reactor is designed, the two circles 39, 40 are selected to determine dimensions and relative sizes between processing chambers 21 and vortex generators 16, 17. The gap between inner inscribed circle 39 and process rotors 22 will then determine rotor size based on processing chamber size. The reactor can be functional in many different sizes as long as these relationships are maintained. The number of apexes in the polygon shaped processing chamber is dependent upon the size of the comminution reactor inscribed circle 40. In one embodiment the vortex generators in the apexes have a diameter of 2 inches and 4¼ inches high and are made of hardened 17-4 ph stainless steel. The vortex generators formed on the wear plates have a ½ inch diameter and 4½ inches height.

A smaller comminution reactor tends to be too round in shape unless the number of apexes is decreased. For larger reactors the number of apexes in the polygon must be increased to keep the radius of the vortex generators 16, 17 large enough to establish effective vortexes. Thus larger reactors have a larger number of apexes (more corners in the polygon) while smaller reactors have fewer (less corners in the polygon) so that all different sizes maintain proper relationship between vortexes and flows. It is helpful to keep the number of vortexes to an odd number to avoid resonance and standing waves inside the reactor.

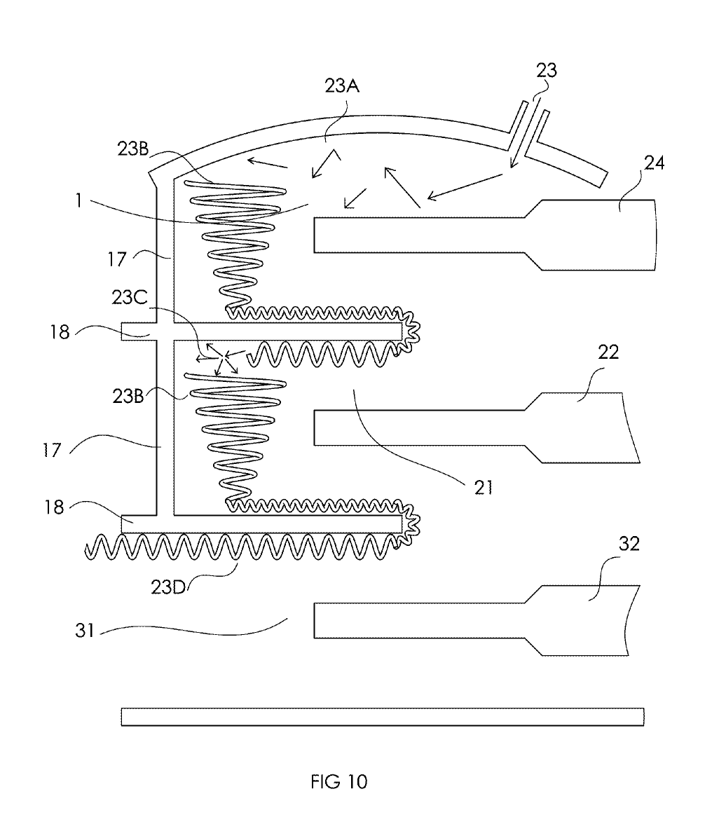

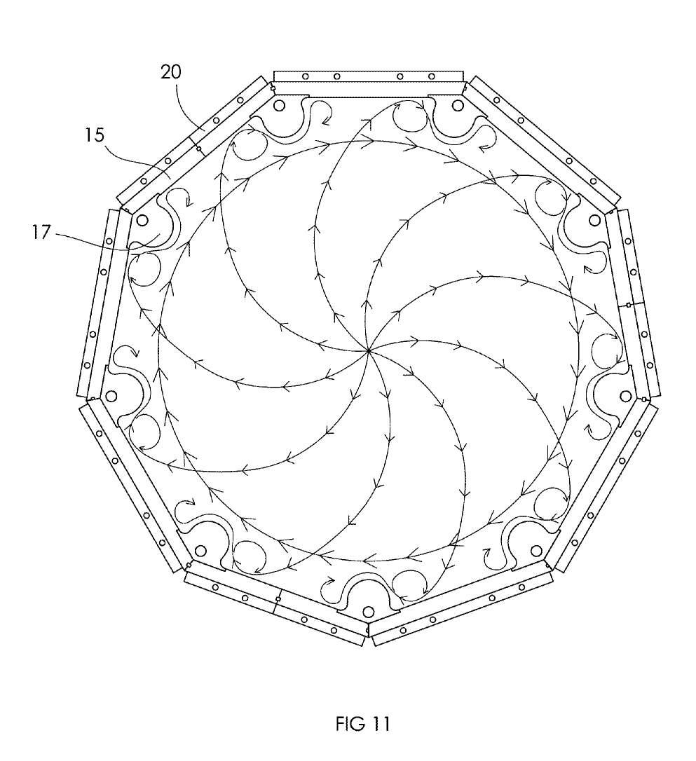

The cross section of the vortex generators resembles the letter Omega. No vortex generator extends inwards further than inner imaginary inscribed circle 39. This inscribed circle also symbolizes the outer edge of the swirling material/fluid curtain circulating the chamber (see FIGS. 10 and 11). The gap between inscribed circle 39 and floating wear plates 15 allows space for vortexes. The distance inwards from circle 39 to the rotor tips allow for proper clearance for the rotor. The actual radius of the vortex generators, properly calculated will minimize material wear on the vortex generators itself as well as dictate correct vortex diameter for maximum collision between material whirling around in the vortex and new material passing through the material flow curtain forced by the rotor and existing swirling material within the flow curtain flowing this circle radius around the process chamber.

FIG. 5B shows horizontal chamber assemblies in their opened position. The segmented split divider plate 18 is hinged on rods 10 kept in position by machine plates 28. Horizontal chamber assemblies in this embodiment include segmented split divider plates 18, floating wear plates 15, retainer plates 20, and vortex generators 16, 17. Shaft 3 and attached rotors 22, 24, 32 are omitted for clarity. Operationally only one of horizontal chamber assemblies needs to be opened for allowing inspection.

This improved design, compared to prior art, allows for the entire rotor assembly (comprising the shafts, rotors, keys, housings, etc.) to be removed intact from the reactor. Either the inlet dome or the discharge volute is removed, and then the rotor assembly is clear to pass through either end.

FIG. 6 is a detailed cutaway plan view of a portion of processing chamber 21 showing apex vortex generators 17 formed at the apexes of floating wear plates 15 and floating wear plate vortex generators 16 formed on floating wear plate 15. Retainer plates 20 are restrained by segmented split divider plates 18 by retainer rods 29 via retainer rod opening 34. Retainer plates 20 position the floating wear plates 15 Inner and outer circles 39, 40 are shown as well as probe hole 19.

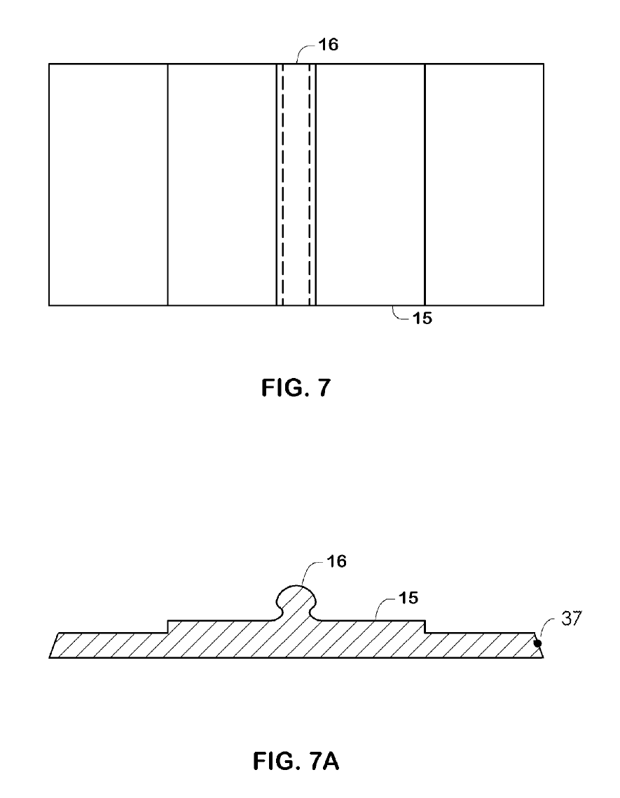

FIG. 7 is a front view of a floating wear plate 15 forming a wear plate vortex generator 16. FIG. 7A is a cross-section view of floating wear plate 15. In this embodiment, wear plate vortex generator 16 is integrally formed with floating wear plate 15. Wear plates 15 are held in position by retainer plates 20. A resilient gasket 37 may be used for a tight fit and to seal the seams between wear plates.

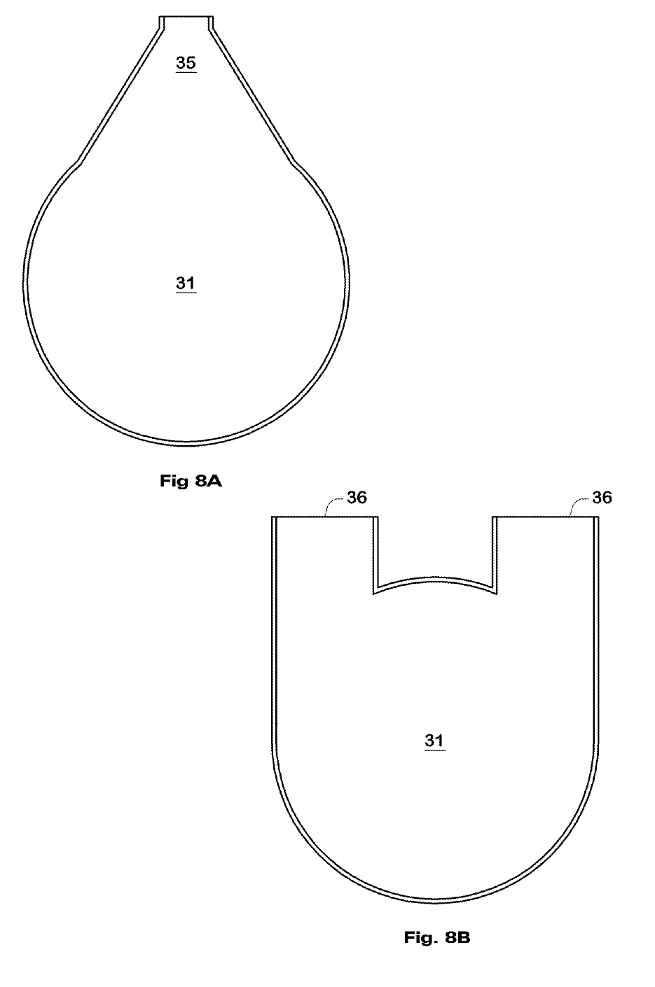

FIG. 8A and 8B are cutaway plan views of the different alternatives for a discharge volute. FIG. 8A shows a single dual volute. Its design allows for discharge of material and fluid through a single opening, regardless of rotation direction. FIG. 8B allow for dual rotation and a discharge of material and fluid through a dual opening.

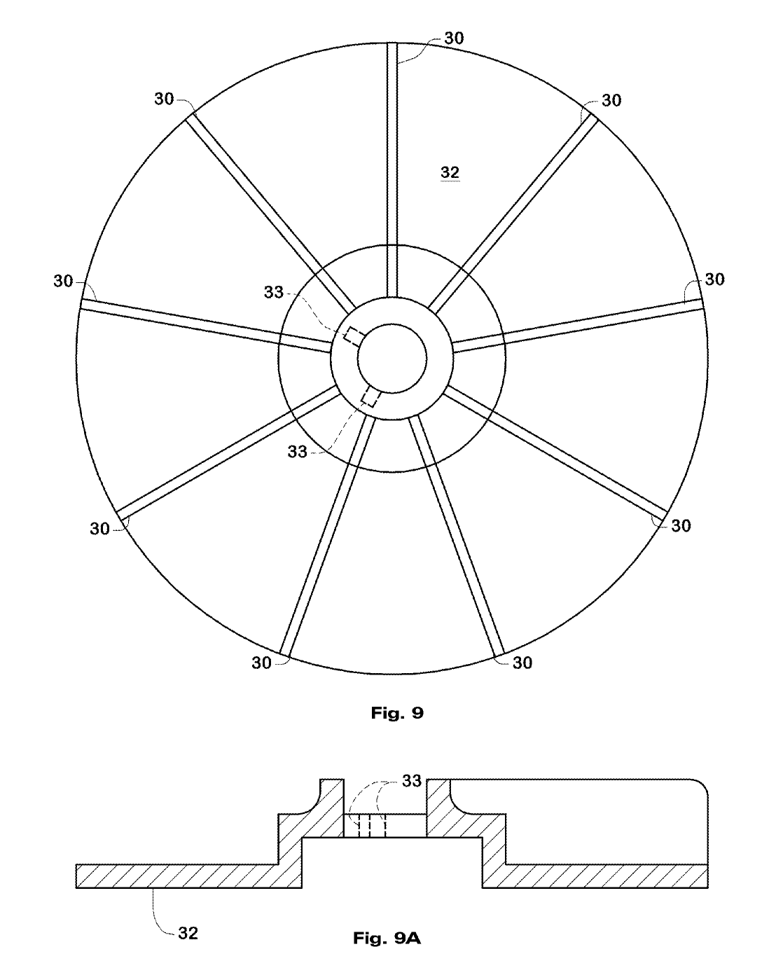

FIG. 9 is a plan view of discharge rotor 32. FIG. 9A is cross-section view of discharge rotor 32. Discharge rotor 32 forms vanes 30 that originate at the central hub and radiate to the round circumference. Vanes 30 have a vertical height that is greater than inlet rotor vanes 25 and processor rotor vanes 12, and sides perpendicular to the base of rotor 32. The height requirement is based on needed pressure and material/fluid density throughout the reactor. The diameter resembles the other rotors. Shaft 3 penetrates the central hub of discharge rotor 32 and is keyed with two keys 33 spaced 90° apart.

FIG. 10 is a schematic side cutaway view of the reactor showing material 23 flow through inlet chamber 1, one processing chamber 21, and discharge chamber 31. Material 23 is shown entering the inlet dome via inlet port 6. After an initial chaotic phase 23A the flow is forced outwards in a more organized fashion. The inlet chambers have a number of vertical vortex generators (not shown in FIG. 10) that each set up two counter rotating vortexes 23B counter to the main flow of material 23A (see FIG. 11). The primary vortex is set up by redirecting the fluid flow back into itself with the help of a vortex generator shaped like the letter Omega. As some material continues and passes over the central ridge in the vortex generator, the Coanda Effect redirects the fluid jet inwards again and along the vortex generator surface. The Coanda Effect is the tendency of a fluid jet to be attracted to a nearby surface. The end result is a secondary identical rotating vortex on the other side of the vortex generator. The two vortexes counter rotating to the main flow create collisions 23C in the fluid streams between the particles with limited interference from either the vortex generators or the floating wear plates in the chamber. The specific design and shape of these vortex generators is what minimize friction and wear and allow comminution of material at very low energy consumption. The present invention is called the Hurricane Comminution Reactor by the inventors.

Underneath inlet rotor 24, the low pressure drags the flow down into processing chamber 21, where the same set-up of several vortexes occurs. The actual comminution occurs mostly in the processing chamber(s) 21. The final step in the process is discharging the fluid/material 23D through a horizontal volute. FIG. 11 is a schematic side cutaway view of fluid/material flow inside a reactor chamber showing material forced outwards by the rotor. As the fluid/material reaches the inscribed circle just inside the vortex generators, it interacts with a circular curtain of fluid/material. The newly injected material collides with other material as it passes through or interacts with the circular movement. Some of the fluid/material passes through and is added to the existing counter-rotating vortexes on either side of each vortex generator. Comminuted particles as well as the fluid is then drawn further into the next chamber based on their specific gravity.

Those skilled in the art of comminution will appreciate that many variations on the embodiments now described and shown fall within the spirit of this invention. For example, the capability that dual direction of rotation allows for fine-tuning energy consumption for different materials. The ability to operating the reactor in reverse makes it possible to seek optimum performance for each individual material. Compared to other milling techniques there is no need for any parameter setting outside speed and feed rate and the reactor gives identical product over its lifespan. Unlike many other milling techniques the reactor's wear does not affect the end result. Furthermore different directions generate different flavors, colors, particle shapes and sizes, and textures in certain kind of materials.

The ability to choose between top or bottom feed by inverting the reactor will change resident time and particle distribution curves. The size of the rotors in combination with rotation speed effects process volumes and feed rates. The ability to vary the numbers of processing chambers allows for customizing the reactor for specific product requirements.

The reactor has a very small footprint relative to actual product through put. The present invention tends to be substantially smaller in physical size compared to traditional mills for the same material and requirements. The actual physical dimensions of the reactor for many applications is 4 ft by 4 ft and yet the reactor has a capacity of several tons per hour, comparable to other mills that can be several times larger.

In general when compared to more traditional milling techniques, the same volume can be comminuted with less energy. Traditional milling techniques based on impact as well as compression require large equipment and due to their design either demand heavy lifting or overcoming extensive friction. Such techniques require large amount of energy in combination with high wear on the equipment itself. The present invention on the other hand gives similar results with substantially less energy and less wear due to its design. As an example, comparative tests of milling oil shale in a traditional mill with the technique of this invention showed that similar results with regards to particle size and throughput could be accomplished with approximately 20% of the energy.

The ability to open up the reactor and allow access to every chamber is important for cleaning, inspection and maintenance. The reactor will comminute material with a wide range of moisture contents from dry to slurry. The segmented design of all wear parts allow for individual cost-effective replacement of any worn parts without extensive downtime. Reactors according to the present invention save on maintenance costs, since all reactor parts are both accessible and interchangeable.

The reactor is by comparison to other milling techniques both quieter and during comminution completely dust free. The design has specifically addressed different issues connected with vibrations. As an example the Reactor does not need to be bolted down during operation. The requirements for different support equipment, such as fans and screens, are substantially reduced.

The comminution reactor can be scaled up as well as scaled down as requested by different end users. The feed materiel being large sized or only available in small quantities demands different comminution capacities. It is, for example, possible to cast smaller rotor assemblies as a single unit and fit the unit into a table top sized reactor, for example around 8 inches in diameter.

What is claimed is:

1-15. (canceled)

16. Apparatus for comminuting material comprising:
a spinnable shaft;
rotor plates attached to the shaft;
wear plates forming a polygon shaped reactor chamber parallel to the shaft, the chamber having an inlet surface at an inlet end and a discharge surface at a discharge end; and
segmented plates disposed between the rotors, the segmented plates extending through the wear plates inward toward the shaft;
wherein a portion of the segmented plates and adjacent wear plates form an assembly constructed to open away from the shaft and the rotors.

17. The apparatus of claim 16 further including vortex generators placed along the wear plates, the vortex generators constructed and arranged to cause vortexes in the material spinning in opposition to a main flow of the material.

18. The apparatus of claim 17 wherein the shaft extends beyond both ends of the reactor chamber and is configured to allow for power coupling at either end.

19. The apparatus of claim 17 wherein the reactor chamber further includes retainer plates outside the wear plates and attached to the segmented plates, the retainer plates disposed to retain the wear plates in position.

20. The apparatus of claim 17 wherein the portion of the reactor chamber between the inlet surface and the segmented plate nearest the inlet surface is designated the inlet chamber, the portion of the reactor chamber between the discharge surface and the segmented plate nearest the outlet surface is designated the discharge chamber, and the portion of the reactor chamber between the inlet chamber and the discharge chamber is designated one or more processing chambers; and
wherein rotors within the inlet chamber, the discharge chamber, and the processing chamber include vanes radiating from hubs of the rotors outward towards the reactor chamber.

21. The apparatus of claim 20 wherein at least one of either the inlet rotor or the process rotor form scallops along the rotor edges between the vanes.

22. The apparatus of claim 17 further comprising oval ports for inserting the material.

23. The apparatus of claim 17 wherein a segmented plate further comprises an opening for insertion of a probe or fluids.

24. The apparatus of claim 16 wherein the reactor chamber further includes retainer plates outside the wear plates and attached to the segmented plates, the retainer plates disposed to retain the wear plates in position.

25. The apparatus of claim 16 wherein the portion of the reactor chamber between the inlet surface and the segmented plate nearest the inlet surface is designated the inlet chamber, the portion of the reactor chamber between the discharge surface and the segmented plate nearest the outlet surface is designated the discharge chamber, and the portion of the reactor chamber between the inlet chamber and the discharge chamber is designated one or more processing chambers; and
wherein rotors within the inlet chamber, the discharge chamber, and the processing chamber include vanes radiating from hubs of the rotors outward towards the reactor chamber.

26. The apparatus of claim 25 wherein at least one of either the inlet rotor or the process rotor form scallops along the rotor edges between the vanes.

27. The method of comminuting materials comprising the steps of:
(a) forming a reactor having a spinnable shaft , forming rotor plates and attaching them to the shaft, wear plates forming a polygon shaped reactor chamber parallel to the shaft, the chamber having an inlet surface at an inlet end and a discharge surface at a discharge end, and disposing segmented divider plates between the rotors, the segmented divider plates extending through the wear plates inward toward the shaft;
(b) constructing an assembly comprising a portion of the segmented plates and adjacent wear plates such that the assembly can selectively open away from the shaft and the rotors;
(c) spinning the shaft and the rotors in either a clockwise or counter clockwise direction;
(d) injecting the material through ports into the inlet end of the reactor chamber;
(e) passing the material through the rotors and segmented plates; and
(f) retrieving the material from the outlet end of the reactor chamber.

28. The method of claim 27 further comprising the step of forming vortexes in the material along the wear plates, the vortexes spinning in opposition to the main flow of the material.

29. The method of claim 28 further comprising the step of forming vortexes in the material at the corners of the reactor chamber.

29. The method of claim 27 further comprising the step of forming vortexes in the material at the corners of the reactor chamber.

30. The method of claim 27 further comprising the step of removing either the inlet surface or the discharge surface and removing the shaft and the attached rotors as a unit.

31. The method of claim 27 further comprising the step of uncoupling an end of the shaft from a motor, inverting the reactor chamber, and coupling the other end of the shaft to the motor.

32. The method of claim 27 wherein the step of constructing an assembly includes the steps of forming holes in segmented plates of the segment, and hinging the assembly on a rod.

33. The method of claim 27 wherein the step of forming rotor plates includes forming vanes on the rotor plates, the vanes extending from hubs of the rotors towards the reactor chamber, and wherein the step of forming the vanes on the rotor closest to the discharge end forms vanes deeper than the vanes of the other rotors.
